(19) United States
(12) Patent Application Publication
(10) Pub. No.: US 2004/0117387 A1
(43) Pub. Date: Jun. 17, 2004

(54) Database sizing and diagnostic utility

(76) Inventors: Vincent Civetta, Morris Plains, NJ (US); Inna Brovman, Fort Lee, NJ (US); Steve Fabian, Sparta, NJ (US); Isabel Espina, Englewood, NJ (US)

Correspondence Address: THE HECKER LAW GROUP, 1925 CENTURY PARK EAST, SUITE 2300, LOS ANGELES, CA, 90067, US

(21) Appl. No.: 10/648,051

(22) Filed: Aug. 26, 2003

Related U.S. Application Data
(63) Continuation of application No. 09/513,654, filed on Feb. 25, 2000, now abandoned.

(51) Int. Cl. G06F 7/00

(52) U.S. Cl. 707/100

(57) ABSTRACT

A system for automated installation and maintenance of databases. One or more embodiments provide a user interface (or wizard) that obtains information from a user regarding aspects of the network environment and application data requirements. Using the information obtained from the user, a sizing process builds a database, or resizes an existing database, to efficiently match the needs of the user. An automated maintenance process self monitors, diagnoses, and fixes database problems, such as by rebuilding table keys and indexes. When the diagnostic cannot fix a problem, appropriate notification takes place. In one embodiment, the user information is processed using sizing formulas to obtain values for building the database. Database scripts and command files are generated which, when executed, build the appropriately configured database. Also, in accordance with the user information, scripts and command files may be generated that will implement a database backup process upon a user-specified schedule.

This application claims the benefit of U.S. Provisional Application No. ______, filed on Feb. 26, 1999, entitled “Sizing and Diagnostic Utility,” the specification of which is herein incorporated by reference.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

1. Field of the Invention

This invention relates to the field of databases.

2. Background Art

Installing and maintaining a database is a complex and time consuming task. Typically, a specially trained and/or certified person or team is required for installing and setting up a database. Maintaining the database during operation often requires that a service team be contacted to provide support.

Another problem associated with databases is that the database and the application using the database are often independently designed and configured, leading to fragmentation and decreased performance. Further, over time, the data residing in the database changes, as well as the relationships between the data. This too causes fragmentation, even in databases that may have been well-configured initially to suit the original data needs of the user.

Some databases, such as the Oracle™ database, are organized into “tablespaces.” Tablespaces are physical allocations of space that hold related objects such as tables or indexes. Tables and indexes are created in specific tablespaces. These tables and indexes are created with an initial allocation within a tablespace, which is referred to as an “extent.” If a table or index runs out of space in the initial extent, a further pre-defined extent may be allocated. New extents are often allocated from contiguous free space within a tablespace. As a tablespace becomes fragmented, the tablespace's free space can be left in such small blocks that the free space is virtually unusable. Also, when tables or indexes have too many extents, the database's performance degrades. Multiple extents require more physical I/O operations to accomplish a query.

A database solution is desired that minimizes the need for specially trained personnel for configuring and maintaining a database, and addresses the problems associated with database fragmentation, both initially and over time.

### SUMMARY OF THE INVENTION

The invention is a system for automated installation and maintenance of databases. One or more embodiments provide a user interface (or wizard) that obtains information from a user regarding aspects of the network environment and application data requirements. Using the information obtained from the user, a sizing process builds a database, or resizes an existing database, to efficiently match the needs of the user. An automated maintenance process self monitors, diagnoses, and fixes database problems, such as by rebuilding table keys and indexes. When the diagnostic cannot fix a problem, appropriate notification takes place.

In one embodiment, the user information is processed using sizing formulas to obtain values for building the database. Database scripts and command files are generated which, when executed, build the appropriately configured database. Also, in accordance with the user information, scripts and command files may be generated that will implement a database backup process upon a user-specified schedule.

### BRIEF DESCRIPTION OF THE DRAWINGS

FIG. 1 is a block diagram of a general-purpose computer upon which an embodiment of the invention may be implemented.

FIG. 2 is a block diagram of an embodiment of the invention.

FIG. 3 is a flow diagram of a sizing process in accordance with an embodiment of the invention.

FIG. 4 is a flow diagram of a maintenance process in accordance with an embodiment of the invention.

FIGS. 5A-5C are flow diagrams of steps within the process of FIG. 4.

### DETAILED DESCRIPTION OF THE INVENTION

In the following description, numerous specific details are set forth to provide a more thorough description of embodiments of the invention. It will be apparent, however, to one skilled in the art, that the invention may be practiced without these specific details. In other instances, well known features have not been described in detail so as not to obscure the invention.

### Embodiment of General-Purpose Computer Environment

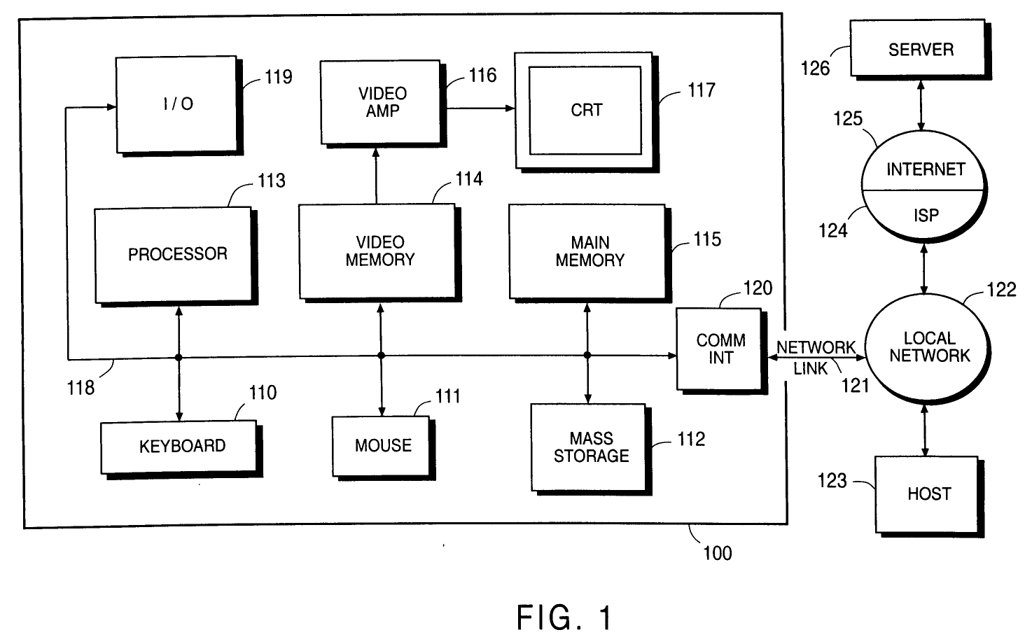

An embodiment of the invention can be implemented as computer software in the form of computer readable program code executed on a general-purpose computer such as computer 100 illustrated in FIG. 1. A keyboard 110 and mouse 111 are coupled to a bi-directional system bus 118. The keyboard and mouse are for introducing user input to the computer system and communicating that user input to central processing unit (CPU) 113. Other suitable input devices may be used in addition to, or in place of, the mouse 111 and keyboard 110. I/O (input/output) unit 119 coupled to bi-directional system bus 118 represents such I/O elements as a printer, A/V (audio/video) I/O, etc.

Computer 100 includes a video memory 114, main memory 115 and mass storage 112, all coupled to bi-directional system bus 118 along with keyboard 110, mouse 111 and CPU 113. The mass storage 112 may include both fixed and removable media, such as magnetic, optical or magnetic optical storage systems or any other available mass storage technology. Bus 118 may contain, for example, thirty-two address lines for addressing video memory 114 or main memory 115. The system bus 118 also includes, for example, a 32-bit data bus for transferring data between and among the components, such as CPU 113, main memory 115, video memory 114 and mass storage 112. Alternatively, multiplex data/address lines may be used instead of separate data and address lines.

In one embodiment of the invention, the CPU 113 is a microprocessor manufactured by Motorola, such as the 680×0 processor or a microprocessor manufactured by Intel, such as the 80×86, or Pentium processor, or a SPARC microprocessor from Sun Microsystems. However, any other suitable microprocessor or microcomputer may be utilized. Main memory 115 is comprised of dynamic random access memory (DRAM). Video memory 114 is a dual-ported video random access memory. One port of the video memory 114 is coupled to video amplifier 116. The video amplifier 116 is used to drive the cathode ray tube (CRT) raster monitor 117. Video amplifier 116 is well known in the art and may be implemented by any suitable apparatus. This circuitry converts pixel data stored in video memory 114 to a raster signal suitable for use by monitor 117. Monitor 117 is a type of monitor suitable for displaying graphic images.

Computer 100 may also include a communication interface 120 coupled to bus 118. Communication interface 120 provides a two-way data communication coupling via a network link 121 to a local network 122. For example, if communication interface 120 is an integrated services digital network (ISDN) card or a modem, communication interface 120 provides a data communication connection to the corresponding type of telephone line, which comprises part of network link 121. If communication interface 120 is a local area network (LAN) card, communication interface 120 provides a data communication connection via network link 121 to a compatible LAN. Wireless links are also possible. In any such implementation, communication interface 120 sends and receives electrical, electromagnetic or optical signals which carry digital data streams representing various types of information.

Network link 121 typically provides data communication through one or more networks to other data devices. For example, network link 121 may provide a connection through local network 122 to host computer 123 or to data equipment operated by an Internet Service Provider (ISP) 124. ISP 124 in turn provides data communication services through the world wide packet data communication network now commonly referred to as the “Internet” 125. Local network 122 and Internet 125 both use electrical, electromagnetic or optical signals which carry digital data streams. The signals through the various networks and the signals on network link 121 and through communication interface 120, which carry the digital data to and from computer 100, are exemplary forms of carrier waves transporting the information.

Computer 100 can send messages and receive data, including program code, through the network(s), network link 121, and communication interface 120. In the Internet example, server 126 might transmit a requested code for an application program through Internet 125, ISP 124, local network 122 and communication interface 120.

The received code may be executed by CPU 113 as it is received, and/or stored in mass storage 112, or other non-volatile storage for later execution. In this manner, computer 100 may obtain application code in the form of a carrier wave.

The computer systems described above are for purposes of example only. An embodiment of the invention may be implemented in any type of computer system or programming or processing environment.

### Embodiment of Database Sizing and Diagnostic Utility

Embodiments of the invention are directed at building and maintaining a database in which the sizing allocations conform to the needs of the user application that is using the database. The initial configuration of the database is performed based on user-provided information about the networking environment and assumptions about the application needs of the user. The user assumptions may become less accurate over time, in which case, an embodiment of the invention may be used to obtain new assumptions from the user regarding application needs. Those new assumptions are then used to resize the database.

As an example, an Oracle database may be used to implement a payroll system application. In such a case, user information is obtained in the form of assumptions about the projected number of employees in the company, the number and types of payroll items that apply to the average employee, etc. The database sizing and diagnostic utility is configured with formulas for converting those payroll assumptions into table parameters that are then used to size the database.

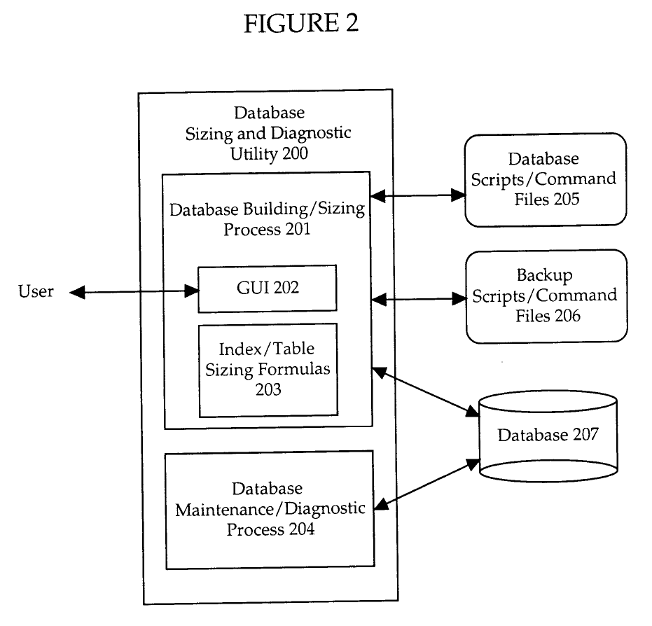

An embodiment of the invention is illustrated in FIG. 2. As shown, a database sizing and diagnostic utility 200 comprises a database building/sizing process 201 and a database maintenance/diagnostic process 204. Within database building/sizing process 201 are a graphic user interface (GUI) 202 (also referred to herein as a “wizard”) and index/table sizing formulas 203.

In one embodiment, GUI 202 presents a sequence of panels for receiving user input. It will be obvious, however, that the invention is not limited to those GUI mechanisms, and that any form of user interface may be employed (e.g., an audio interface). GUI 202 is used to ask questions of the user and to obtain user information in return. The user information comprises information about the networking environment, assumptions about the application-specific needs of the user, and user preferences for database backup operations.

The index/table sizing formulas 203 are used to transform the user information into database sizing parameters that are incorporated into database scripts and command files 205 for building and sizing (or resizing) the database 207. Backup scripts and command files 206 are generated by database building and sizing process 201 from the user-specified backup preferences.

Database maintenance/diagnostic process 204 executes on a periodic basis to evaluate the performance of the database (though a user may also manually prompt the database maintenance/diagnostic process 204 to execute). Entries made to a logfile may serve as an indicator to a user that it may be appropriate to resize the database 207. Problems with tables and indexes which are identified by the database maintenance/diagnostic process 204 are automatically fixed when possible.

### Database Building/Sizing Process

The database building and sizing process 203 is used by the user to optionally install and configure the database engine on their network server, and to build a pre-sized database for a given database application. The advantage of presizing the database correctly is a reduction in tablespace fragmentation and increased performance. Presizing the database, along with the automated database maintenance/diagnostic process 204, permit a user to install a database application without requiring an on-site certified database specialist to manage the database.

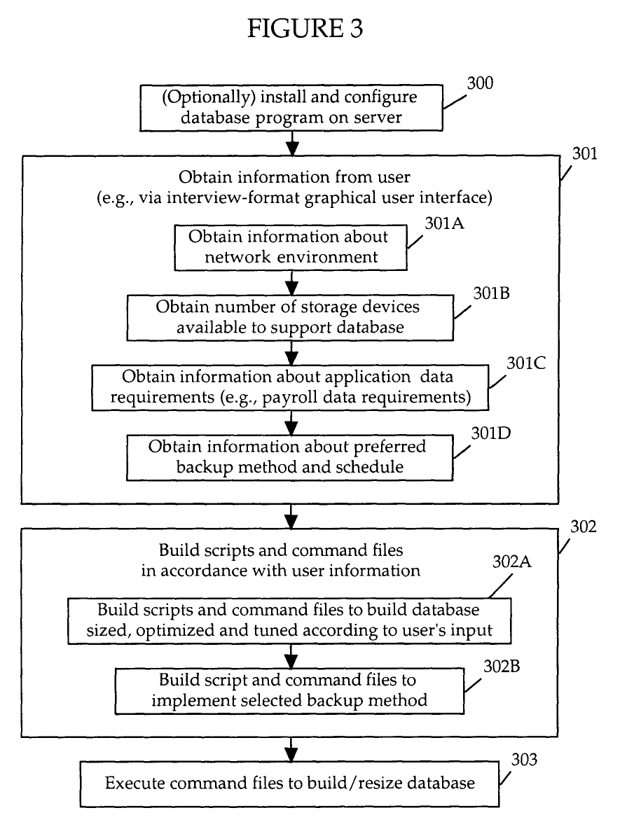

FIG. 3 is a flow diagram of the database building/sizing process 201 in accordance with an embodiment of the invention. In step 300, process 201 optionally installs and configures the database engine on the user's server machine. If this is a resizing operation or if the database engine is already installed, step 300 is skipped. In step 301, the database building/sizing process 201 collects information from the user via GUI 202 (e.g., in interview format).

Step 301 is subdivided into component steps 301A-301B. In step 301A, the user information obtained includes information regarding the user's network environment (number of users and amount of RAM, for instance). In step 301B, process 201 obtains information from the user regarding how many drives the user wants the database to span. In step 301C, the user information obtained concerns the data requirements of the database application, e.g., for a payroll application, the user's payroll data requirements (number of employees, number of company codes, and amount of history to keep online, for instance). In step 301D, GUI 202 obtains the user's preferences for database backup operations, including the backup mode (if more than one mode is available) and the backup schedule.

In step 302, the database building/sizing process 201 generates a series of instructions, for example SQL scripts and Windows NT command files, in accordance with the user information obtained in step 301. Specifically, in step 302A, instructions are generated to physically create a database that will sufficiently house the user's data, and that will be optimized and tuned to perform as well as possible, e.g., based on the network environment information and other user information. In step 302B, instructions are generated to implement the specified periodic backup operation. In step 303, database building/sizing process 201 executes the command files to physically build the database.

In one embodiment of the invention, database building/sizing process 201 and its constituent GUI 202 are implemented as a “wizard” application. The user is presented with a sequence of panels from which the user information of step 301 is obtained. One possible implementation of such a wizard application is described in Appendix A, with corresponding pseudo-code, under the heading “dbsizer.exe: Oracle Sizing Wizard.” A database utility program for performing certain database procedures with command line parameters is described in Appendix A under the heading of “brunner.exe: Database Utility Program,” with accompanying pseudo-code and source code.

### Database Maintenance/Diagnostic Process

The database maintenance/diagnostic process 204 is an unattended database diagnostic and auto-maintenance utility used by the user to perform the following database procedures:

1. check the database for tablespace fragmentation

2. check the tablespaces for available free space

3. check the hard drives for available free space

4. fix any problems that can be fixed automatically without risk

The database maintenance/diagnostic process 204 is scheduled to run at intervals, e.g., once per week, and terminates automatically upon completion. Process messages and errors are written to a logfile for user reference.

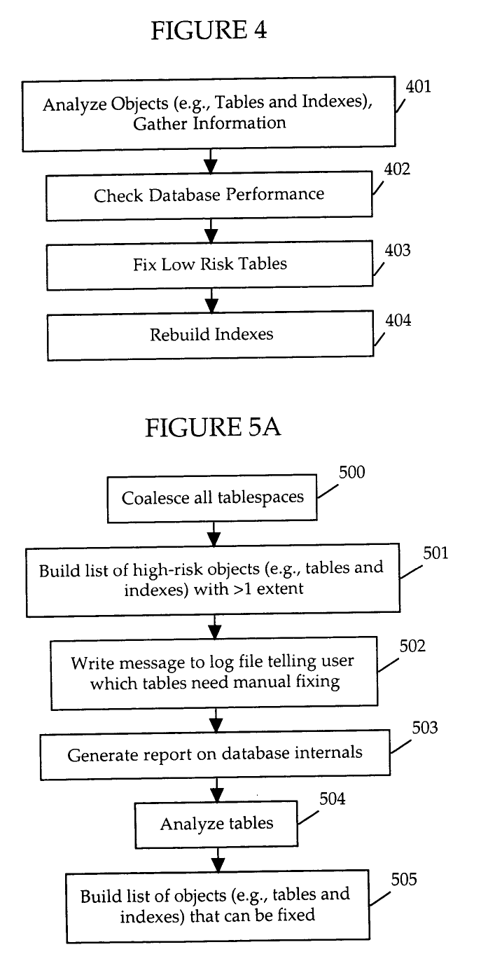

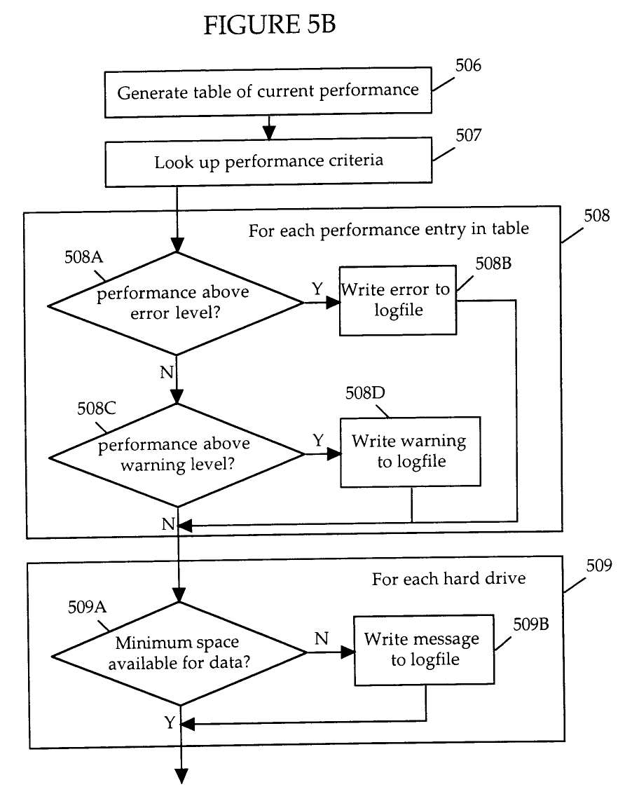

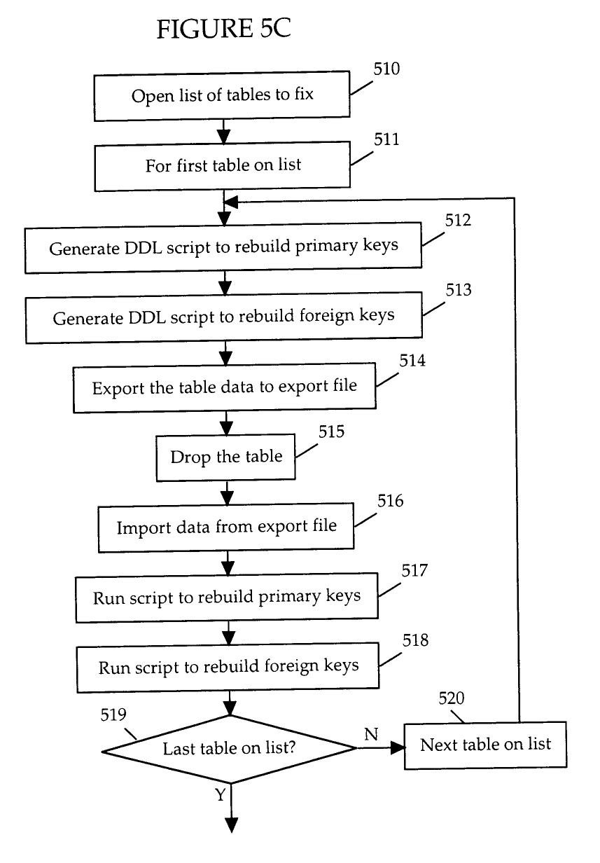

The general flow of the maintenance/diagnostic process is illustrated in FIG. 4. In step 401, all objects (e.g., tables and indexes) are analyzed, and information is gathered regarding those objects that can be fixed automatically and those objects that require manual fixing. In step 402, the database performance is evaluated, with problem areas noted in the logfile. In step 403, those tables that were designated for automatic fixing in step 401 are fixed. In step 404, indexes are rebuilt where necessary. Steps 401-403 are described in more detail below with reference to FIGS. 5A-5C, respectively.

FIG. 5A is directed to table analysis and the gathering of information about the database. In step 500, the database maintenance/diagnostic process 204 coalesces all tablespaces, and, in step 501, builds a list of all high-risk objects with extents greater than one. Objects are considered high-risk if their extents are numerous enough that an automatic fixing operation could compromise their integrity. These high-risk objects are listed in the logfile, in step 502, as objects that will require manual fixing. In step 503, a report is generated on the database internals. In step 504, all tables are analyzed, and in step 505, a list is made of those objects that should be automatically fixed by the database maintenance/diagnostic process.

FIG. 5B illustrates steps for performing database performance analysis. In step 506, a table is generated that contains entries for database performance values in different categories. In step 507, performance criteria are obtained that specify, for example, error levels and warning levels for each performance category. Step 508, comprising steps 508A-508D, is performed for each entry in the performance table generated in step 506. In step 508A, the performance value for one entry in the table is compared with the corresponding error level. If the performance value is above the specified error level, an error message is written to the logfile in step 508B, and the process continues at step 509. If, in step 508A, the performance value is not above the error level, then the performance value is compared with the warning level in step 508C. If the performance value is above the error level, a warning message is written to the logfile in step 508D before proceeding to step 509. If the performance value is not above the warning level in step 508C, the process continues at step 509.

Step 509, comprising steps 509A-509B, is performed for each hard drive upon which the database is spread. In step 509A, the free space of the hard drive is compared with a minimum space threshold value needed to support the database. If the free space available does not meet the minimum space threshold value, a warning message is written to the logfile in step 509B.

FIG. 5C illustrates one method for fixing tables in accordance with an embodiment of the invention. In step 510, the database maintenance/diagnostic process 204 opens the list of tables that can be automatically fixed. In step 511, the first table listed is selected for fixing. In step 512, a DDL script is generated that will rebuild the primary keys of the table, and, in step 513, a DDL script is similarly generated to rebuild the table's foreign keys.

In step 514, the table data is exported to an export file and, in step 515, the table is dropped. In step 516, the table data in the export file is imported back in. In steps 517 and 518, respectively, the primary key and foreign key rebuild scripts are run to fix the table. In step 519, if the current table is not the last table on the list, the next table is selected and the process continues at step 512; otherwise, the process continues in step 404 of FIG. 4.

One possible implementation of database maintenance/diagnostic process 204 is described in Appendix A, with corresponding pseudo-code and source code, under the heading “hwb.exe: Health and Well-Being Utility.”

Thus, a database sizing and diagnostic utility has been described in conjunction with one or more embodiments. The invention is defined by the claims and their full scope of equivalents.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. In a computer system, a method for building and sizing database tables comprising:
obtaining data requirement information;
performing a diagnosis on at least one database table;
obtaining a new size for said at least one database table using a result from said diagnosis and said data requirement information;
building said at least one database table; and
performing maintenance on said at least one database table.

2. The method of claim 1 wherein said obtaining said data requirement information further comprises obtaining user input.

3. The method of claim 2 wherein said obtaining said user input further comprises providing at least one user interface for obtaining said data requirement information.

4. The method of claim 1 wherein said obtaining said data requirement information further comprises obtaining network environment information.

5. The method of claim 1 wherein said obtaining said data requirement information further comprises obtaining information about storage devices available to support said at least one database table.

6. The method of claim 1 wherein said obtaining said data requirement information further comprises obtaining a backup method.

7. The method of claim 1 wherein said obtaining data requirement information further comprises obtaining a backup schedule.

8. The method of claim 1 wherein said obtaining data requirement information further comprises obtaining at least one requirement of at least one application.

9. The method of claim 1 wherein said performing a diagnosis on said at least one database table further comprises checking performance measures.

10. The method of claim 9 wherein said checking performance measures comprises generating a table of current performance.

11. The method of claim 9 wherein said checking performance measures comprises looking up performance criteria.

12. The method of claim 11 wherein said looking up performance criteria comprises checking an error level.

13. The method of claim 12 wherein said checking said error level comprises writing at least one error message to an error log.

14. The method of claim 9 wherein said checking performance measures comprises checking whether performance is above a warning level.

15. The method of claim 14 further comprising writing a warning message to a warning log when said performance is above said warning level.

16. The method of claim 9 wherein said checking said database performance further comprises determining a minimum space available for data.

17. The method of claim 1 wherein said performing said diagnosis on said at least one database table further comprises analyzing a plurality of objects contained in said at least one data base table.

18. The method of claim 17 wherein said analyzing said plurality of objects further comprises building a list of high-risk objects.

19. The method of claim 17 wherein said analyzing said plurality of objects further comprises building a list of objects that can be fixed.

20. The method of claim 1 wherein said performing said diagnosis on said at least one database table further comprises generating at least one report on internals of said at least one database table.

21. The method of claim 1 wherein said obtaining said new size further comprises utilizing a set of formulas to compute said new size.

22. The method of claim 1 wherein said performing said maintenance further comprises generating at least one maintenance script.

23. The method of claim 1 wherein said performing said maintenance further comprises rebuilding at least one index for said at least one database table.

24. A system comprising
a processor;
a memory coupled to said processor;
computer program code executed by said processor configured to:
obtain data requirement information;
perform a diagnosis on at least one database table;
obtain a new size for said at least one database table using a result from said diagnosis and said data requirement information;
build said at least one database table; and
perform a maintenance on said at least one database table.

25. The system of claim 24 wherein said computer program code configured to obtain said data requirement information further comprises computer program code configured to obtain user input.

26. The system of claim 25 wherein said computer program code configured to obtain said user input further comprises computer program code configured to provide at least one interface for obtaining said data requirement information.

27. The system of claim 24 wherein said computer program code configured to obtain said data requirement information is further configured to obtain network environment information.

28. The system of claim 24 wherein said computer program code configured to obtain said data requirement information is further configured to obtain information about storage devices available to support said at least one database table.

29. The system of claim 24 wherein said computer program code configured to obtain said data requirement information is further configured to obtain information about a backup method.

30. The system of claim 24 wherein said computer program code configured to obtain said data requirement information is further configured to obtain a backup schedule.

31. The system of claim 24 wherein said computer program code configured to obtain said data requirement information is further configured to obtain a requirement of at least one application.

32. The system of claim 24 wherein said computer program code configured to perform a diagnosis on at least one database table further comprises computer program code configured to check database performance.

33. The system of claim 32 wherein said computer program code configured to check said database performance further comprises computer program code configured to generate a table of current performance.

34. The system of claim 32 wherein said computer program code configured to check said database performance further comprises computer program code configured to look up performance criteria.

35. The system of claim 34 wherein said computer program code configured to look up said performance criteria further comprises computer program code configured to check an error level.

36. The system of claim 35 wherein said computer program code configured to check said error level further comprises computer program code configured to write at least one error message to an error log.

37. The system of claim 32 wherein said computer program code configured to check said database performance further comprises computer program code configured to check whether said database performance is above a warning level.

38. The system of claim 37 further comprising computer program code configured to write a warning message to a warning log.

39. The system of claim 32 wherein said computer program code configured to check said database performance is further configured to determine a minimum space available for data.

40. The system of claim 24 wherein said computer program code configured to perform a diagnosis on said at least one database table is further configured to analyze a plurality of objects contained in said at least one database table.

41. The system of claim 40 wherein said computer program code configured to analyze said plurality of objects is further configured to build a list of high-risk objects.

42. The system of claim 40 wherein said computer program code configured to analyze said plurality of objects is further configured to build a list of objects that can be fixed.

43. The system of claim 24 wherein said computer program code configured to perform a diagnosis on said at least one database table is further configured to generate at least one report on internals of said database.

44. The system of claim 24 wherein said obtaining said new size further comprises utilizing a set of formulas to compute said new size.

45. The system of claim 24 wherein said computer program code configured to perform said maintenance is further configured to rebuild at least one index for said at least one database table.

46. The system of claim 24 wherein said computer program code configured to perform said maintenance is further configured to generate at least one maintenance script.
